(19) United States
(12) Patent Application Publication
(10) Pub. No.: US 2007/0167194 A1
(43) Pub. Date: Jul. 19, 2007

(54) Plural wirelessly connected devices with user alarm if wireless connection is lost or endangered

(75) Inventors: Michael K. Brown, Kitchener (CA); Neil P. Adams, Waterloo (CA); Herbert A. Little, Waterloo (CA); Scott W. Totzke, Waterloo (CA)

Correspondence Address: NIXON & VANDERHYE, PC, 901 NORTH GLEBE ROAD, 11TH FLOOR, ARLINGTON, VA, 22203, US

(73) Assignee: RESEARCH IN MOTION LIMITED, Waterloo (CA)

(21) Appl. No.: 11/331,338

(22) Filed: Jan. 13, 2006

(51) Int. Cl. H04B 1/38

(52) U.S. Cl. 455/567; 455/558

(57) ABSTRACT

A portable wireless user communication device is wirelessly coupled to a second device over a monitored link. If the link is lost or endangered, then a user alarm is activated at the portable wireless user device and/or at the second device to which it is linked (which may also be a portable electronic device). The type of monitoring and/or the type of alarming may be user selectable.

### BACKGROUND

1. Technical Field

This specification generally relates to plural wirelessly connected devices, at least one of such devices being portable—and possibly both or all such devices being portable.

2. Description of Related Art

It is now becoming commonplace for portable electronic devices to be wirelessly connected with other (portable or non-portable) electronic devices. For example, using Bluetooth technology, short range RF wireless communication links may be established between related devices (e.g., between a cellular telephone and its earpiece/microphone assembly that may be configured to mount on a user's ear or the like). Infrared and other types of short range wireless communication links are, of course, also well known in the art between related electronic devices.

Some such cooperating devices provide security features to guard against unauthorized usage of one or both of the cooperating wirelessly-connected devices. For example, a smart card reader may include cryptographic security information (on an inserted smart card) associated with an authorized user. The smart card reader with a cryptographic/security smart card connected therein may be sufficiently small to be carried at all times on the person authorized to use some other associated device (e.g., a portable communication device such as a cell phone, wireless communication device or the like). In such situations, the protected device may be configured to lock up, shut down, or otherwise become disabled if its connection link with the authorizing smart card reader is broken. While this does provide needed security, it can also cause a nuisance (e.g., if a user forgetfully leaves one of the protected devices on a restaurant table, airplane, car, etc. and then walks out of range, the authorizing security communication link is broken). Even if the authorized user later remembers the forgotten device and comes back to get it, once having breached security protocols, re-establishing authorized use may involve additional effort and/or time.

One prior approach towards enabling/disabling an electronic device display based upon separation between a wirelessly linked pc and a remote electronic device is described at U.S. Pat. No. 6,594,762. Here, the display of a personal computer is enabled only if an authorized remote user device is within a relatively near distance or proximity to the personal computer. However, this simply illustrates the problem described above where a user may forgetfully break the wireless communication link without intending to do so—and then suffer adverse consequences. It offers no user warning alarm if the link is broken or endangered.

### BRIEF DESCRIPTION OF THE DRAWINGS

These and other objects and advantages of this invention will be more completely understood and appreciated by careful study of the following more detailed description of at least one exemplary embodiment in conjunction with the accompanying drawings, in which:

FIG. 1 is an overall system wide schematic view of an exemplary wireless email communication system incorporating a mobile wireless communication device providing a user alarm if a wireless connection to an associated smart card reader is lost or endangered;

FIG. 2 is an abbreviated schematic diagram of hardware typically included within an exemplary mobile wireless communication device of the type shown in FIG. 1;

FIGS. 3A and 3B provide an exemplary abbreviated schematic flow diagram of computer software (i.e., program logic) that may be utilized in the mobile wireless communication device(s) of FIG. 1 to monitor a wireless connection and to provide a user alarm; and

FIGS. 4A and 4B provide an exemplary abbreviated schematic flow diagram of computer software (i.e., program logic) that may be utilized in the mobile wireless communication device(s) of FIG. 1 to enable a user to set personal profile preferences for the type of connection monitor and/or user alarm.

### DETAILED DESCRIPTION OF EXEMPLARY EMBODIMENTS

We now provide a user alarm if a wireless connection between related devices is lost or endangered.

For example, if one is using a smart card reader with a portable wireless communication device for access control, if the smart card reader and the wireless communication device are separated beyond usable wireless link range, then the wireless communication device will lock up. However, as a user, it would be a great improvement to know about this when it happens so that the situation can be rectified (or perhaps even prevented if a warning signal is given in advance of actual link loss).

For example, if one forgetfully leaves the smart card reader in a restaurant, a user alarm can provide immediate notification that the smart card reader was forgotten while it is still convenient and timely to go back and retrieve it from the restaurant. This is considerably better than perhaps discovering an hour or so later that the wireless communication device is locked when one next goes to use it.

In the exemplary embodiment, a wireless communication device (and quite possibly the smart card reader itself) monitors a Bluetooth wireless connection with a smart card reader access control device. If it is determined that the connection has been broken (or is endangered), then the user is notified with an attention-getting alarm. For example, an audible beep or ringtone may be used to audibly alert the user or tactile senses may be used via a vibrator output or other types of alarms such as a visual alarm like a flashing LED or LCD might be used.

Preferably, the type of alarming notification may be selectively controlled by the user who may be given an option (e.g., via an existing user profile application) to specify the desired type of alarm notification. The type of notification could even be automatically changed in response to sensed changes in a current user profile (e.g., if the user selects a vibrator output for incoming message notifications, then a vibrator alarm output could also be automatically chosen).

In addition, if the security device (e.g., smart card reader) is outfitted with sufficient hardware (e.g., an audible speaker, tactile vibrator or flashing light), it could also be programmed to provide an alarm notification to the user such that if the situation is reversed (e.g., the wireless communication device is forgetfully left at the restaurant), then the user could also receive an alarm notification to permit quick and convenient rectification of the situation.

There are a number of wireless link monitoring techniques that may be employed. To enhance security features, if a cryptographically secure “heartbeat” is available on the link, then such a “secure” heartbeat may be monitored and one or a number of missing secure heartbeats would then be interpreted as a broken or endangered link such as to generate a suitable alarm. If a secure heartbeat signal is not present (or if for some reason it is not desired to monitor the secure heartbeat), then typically another non-secure (possibly low level, infrequently occurring) link heartbeat may be monitored to ascertain continued viability of the wireless link. Still further, or alternatively, signal power on the link may be monitored so as to detect when it passes below one or more thresholds indicating that the link is either endangered or no longer useful (i.e., broken).

In exemplary embodiments herein described, the user is given an attention-getting signal (e.g., audible, tactile or visual) that is not likely to be ignored or unnoticed when the two wirelessly-connected devices lose their connection (or the connection is endangered). In one exemplary embodiment, both devices connected by the monitored wireless link are portable. However, it is also possible that our alarming techniques could be utilized to monitor wireless communication links between one or more portable devices and one or more non-portable devices.

The described embodiments may be realized in hardware, software or a combination of hardware and software and provide a method for monitoring a wireless connection between plural devices and generating a user alarm if the wireless connection is lost or endangered. The exemplary embodiments are realized, at least in part, by executable computer program code which may be embodied in physical digital memory media.

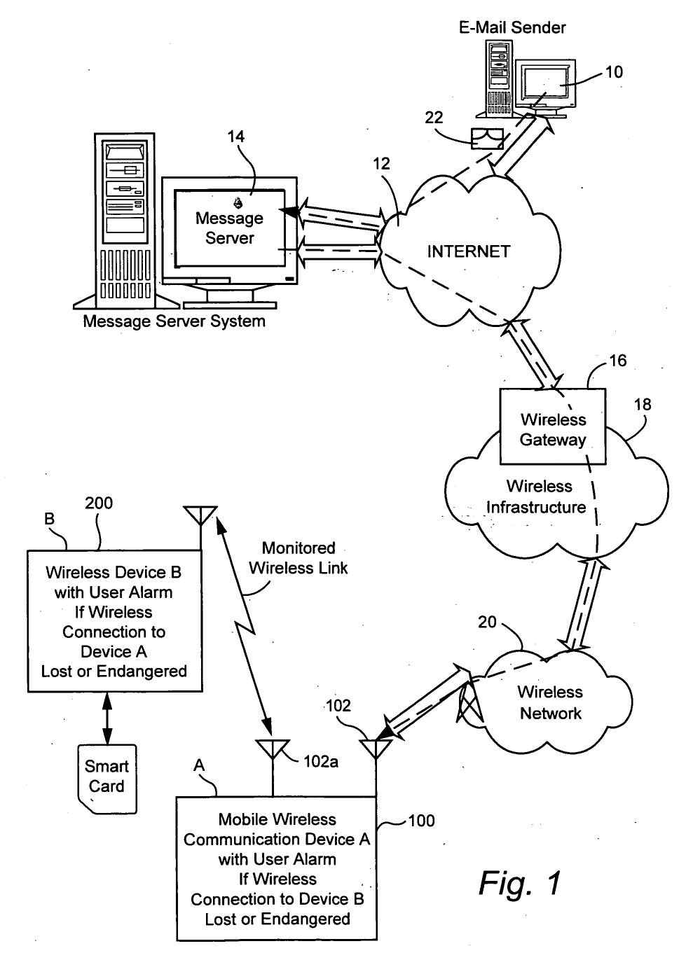

FIG. 1 is an overview of an exemplary communication system in which a wireless communication device 100 may be used. One skilled in the art will appreciate that there may be hundreds of different system topologies. There may also be many message senders and recipients. The simple exemplary system shown in FIG. 1 is for illustrative purposes only, and shows perhaps the currently most prevalent Internet email environment.

FIG. 1 shows an email sender 10, the Internet 12, a message server system 14, a wireless gateway 16, wireless infrastructure 18, a wireless network 20 and a mobile communication device 100.

An email sender 10 may, for example, be connected to an ISP (Internet service Provider) on which a user of the system has an account, located within a company, possibly connected to a local area network (LAN), and connected to the Internet 12, or connected to the Internet 12 through a large ASP (application service provider) such as America Online™ (AOL). Those skilled in the art will appreciate that the systems shown in FIG. 1 may instead be connected to a wide area network (WAN) other than the Internet, although email transfers are commonly accomplished through Internet-connected arrangements as shown in FIG. 1.

The message server 14 may be implemented, for example, on a network computer within the firewall of a corporation, a computer within an ISP or ASP system or the like, and acts as the main interface for email exchange over the Internet 12. Although other messaging systems might not require a message server system 14, a mobile device 100 configured for receiving and possibly sending email will normally be associated with an account on a message server. Perhaps the two most common message servers are Microsoft Exchange™ and Lotus Domino™. These products are often used in conjunction with Internet mail routers that route and deliver mail. These intermediate components are not shown in FIG. 1, as they do not directly play a role in the invention described below. Message servers such as server 14 typically extend beyond just email sending and receiving; they also include dynamic database storage engines that have predefined database formats for data like calendars, to-do lists, task lists, email and documentation.

The Wireless gateway 16 and infrastructure 18 provide a link between the Internet 12 and wireless network 20. The wireless infrastructure 18 determines the most likely network for locating a given user and tracks the users as they roam between countries or networks. A message is then delivered to the mobile device 100 via wireless transmission, typically at a radio frequency (RF), from a base station in the wireless network 20 to the mobile device 100. The particular network 20 may be virtually any wireless network over which messages may be exchanged with a mobile communication device.

As shown in FIG. 1, a composed email message 22 is sent by the email sender 10, located somewhere on the Internet 12. This message 22 typically uses traditional Simple Mail Transfer Protocol (SMTP), RFC 822 headers and Multipurpose Internet Mail Extension (MIME) body parts to define the format of the mail message. These techniques are all well known to those skilled in the art. The message 22 arrives at the message server 14 and is normally stored in a message store. Most known messaging systems support a so-called “pull” message access scheme, wherein the mobile device 100 must request that stored messages be forwarded by the message server to the mobile device 100. Some systems provide for automatic routing of such messages which are addressed using a specific email address associated with the mobile device 100. In a preferred embodiment, messages addressed to a message server account associated with a host system such as a home computer or office computer which belongs to the user of a mobile device 100 are redirected from the message server 14 to the mobile device 100 as they are received. Messages will typically be encrypted from sender to receiver by utilizing a key that is unique to a given device. Examples of two commonly used methods are the Data Encryption Standard (Triple-DES) and the Advanced Encryption Standard (AES).

Regardless of the specific mechanism controlling forwarding of messages to mobile device 100 , the message 22, or possibly a translated or reformatted version thereof, is sent to wireless gateway 16. The wireless infrastructure 18 includes a series of connections to wireless network 20. These connections could be Integrated Services Digital Network (ISDN), Frame Relay or T1 connections using the TCP/IP protocol used throughout the Internet. As used herein, the term “wireless network” is intended to include three different types of networks, those being (1) data-centric wireless networks, (2) voice-centric wireless networks and (3) dual-mode networks that can support both voice and data communications over the same physical base stations. Combined dual-mode networks include, but are not limited to, (1) Code Division Multiple Access (CDMA) networks, (2) the Group Special Mobile or the Global System for Mobile Communications (GSM) and the General Packet Radio Service (GPRS) networks, and (3) future third-generation (3G) networks like Enhanced Data-rates for Global Evolution (EDGE) and Universal Mobile Telecommunications Systems (UMTS). Some older examples of data-centric network include the Mobitex™ Radio Network and the DataTAC™ Radio Network. Examples of older voice-centric data networks include Personal Communication Systems (PCS) networks like GSM, and TDMA systems.

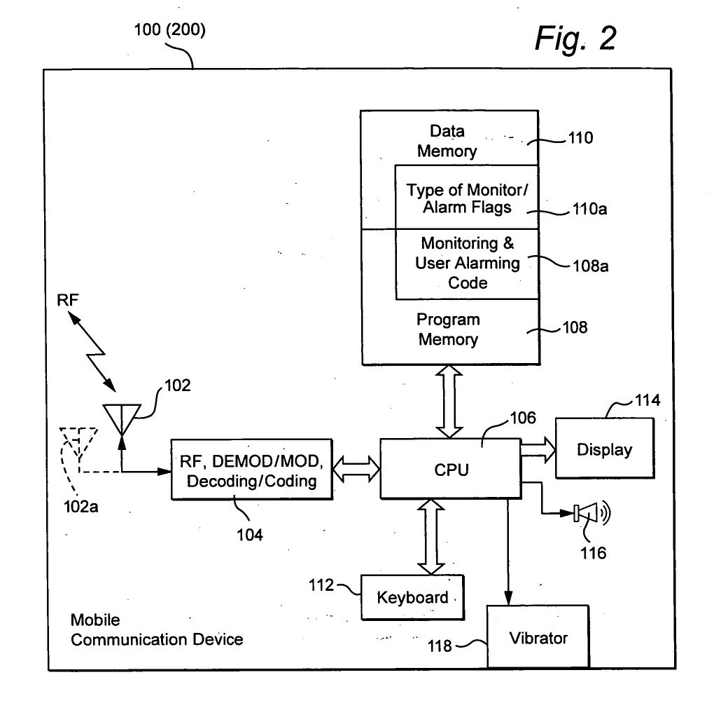

As depicted in FIG. 2, mobile communication device 100 includes a suitable RF antenna 102 for wireless communication to/from wireless network 20. Conventional RF, demodulation/modulation and decoding/coding circuits 104 are provided. As those in the art will appreciate, such circuits can involve possibly many digital signal processors (DSPs), microprocessors, filters, analog and digital circuits and the like. However, since such circuitry is well known in the art, it is not further described.

The mobile communication device 100 will also typically include a main control CPU 106 which operates under control of a stored program in program memory 108 (and which has access to data memory 110). CPU 106 also communicates with a conventional keyboard 112, display 114 (e.g., an LCD) an audio transducer or speaker 116 and a vibrator transducer 118. A portion of data memory 110a is available for storing flags indicating the type of link monitoring and/or user alarms to be used. Suitable computer program executable code is stored in portions of program memory 108a to constitute the program logic for effecting link monitoring and the issuing of a suitable user alarm if the monitored link is endangered or lost.

As indicated in parenthesis at FIG. 2, the mobile communication device depicted may also generally describe the smart card reader 200 (wireless device B shown in FIG. 1 and wirelessly linked to the mobile communication device 100). Of course, the wireless device 200 would also include a smart card connection interface port to CPU 106. Due to the relatively smaller size of a typical smart card reader 200, the user interface may comprise only a single button, one or more LED lights and/or a relatively small status display. Preferably, in the exemplary embodiment, the smart card reader 200 will also include a speaker 116 and/or vibrator 118 if the smart card reader 200 is to be provided with a user alarm feature (e.g., a flashing LED). As will be recognized, the user alarm herein described may be provided in either wireless device 100 or wireless device 200 or in both as may be desired for a particular application.

As depicted in dotted lines at FIG. 2, a separate antenna 102a may be provided for the monitored wireless link (the main antenna 102 being utilized perhaps at different frequency bands and/or modes of RF communication to provide the main functional wireless communication link to network 20 as depicted in FIG. 1). As those in the art will appreciate, the usual Bluetooth link (if that happens to be employed for the monitored wireless link) may utilize an antenna and RF processing circuits that are in common usage for other purposes. Alternatively, antenna/RF processing circuits dedicated to the Bluetooth (or other monitored wireless link) may be additionally provided as will be apparent to those in the art.

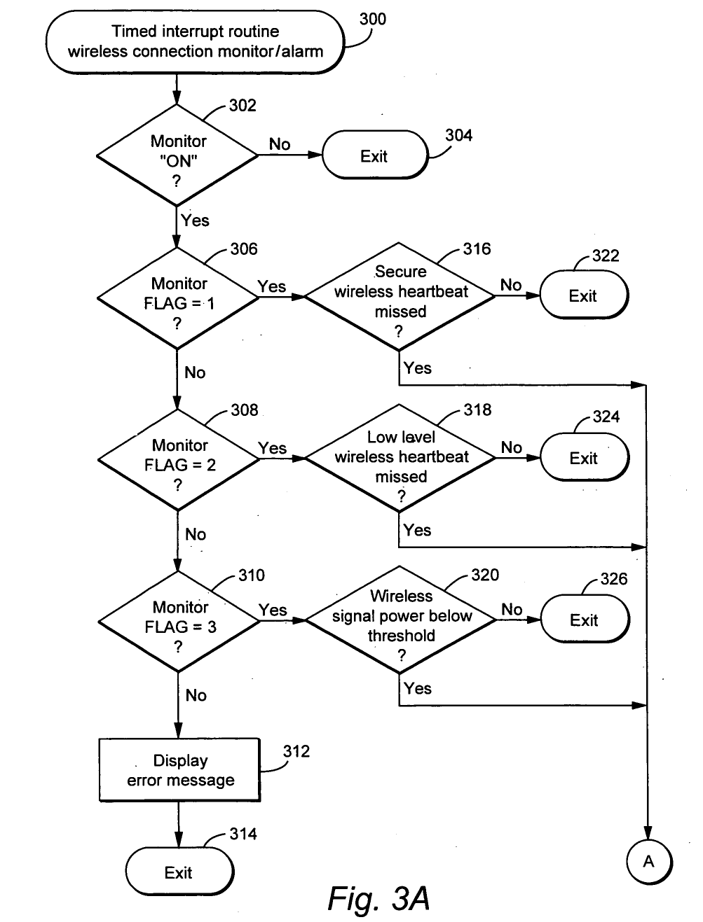

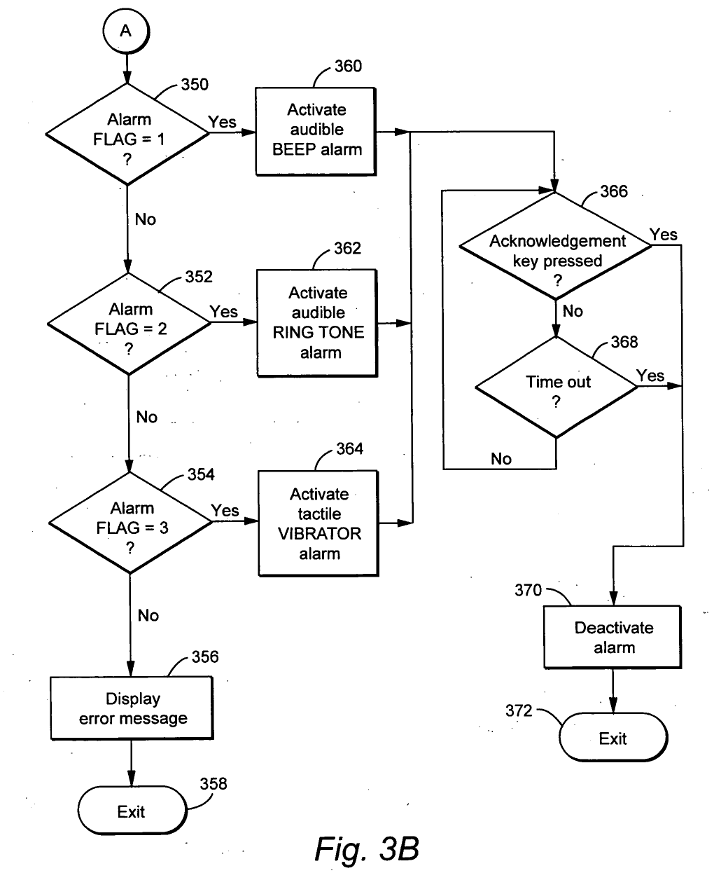

A timed interrupt routine for monitoring the wireless connection and generating an alarm if appropriate is depicted at FIGS. 3A-3B. The timed interrupt routine 300 may be entered relatively infrequently thus minimizing extra processing load on the CPU 106. For example, some typical “heartbeat” signals of an operating wireless link may only occur relatively infrequently (perhaps only once every 30 seconds or so). This may be especially true for “secure” heartbeats which require cryptographic processing. Accordingly, the monitoring function need not be performed any more frequently than the expected occurrences of the monitored link characteristic.

After entry to the timed interrupt routine at 300, a test is made at 302 to see if the monitoring function is currently “ON”. If not, then exit is taken at 304. However, if the monitoring function is “ON”, then tests are made successively at 306, 308 and 310 to determine the value of the monitor flag (indicating the type of monitoring to be conducted). If the monitoring flag does not have an expected value, then an error message is displayed at 312 and the routine is exited at 314. However, if the monitoring flag has an expected value, then the link characteristic associated with the flag value is tested for at 316, 318 and 320 respectively. If no problem is found, then the routine is merely exited at 322, 324 and 326 respectively. However, if a problem is discovered, then the routine passes control to a series of alarm flag tests at 350, 352 and 354 (shown in FIG. 3B). If no expected alarm flag value is detected, then an error message is displayed at 356 and exit is taken at 358. However, if an expected alarm flag value is detected, then a branch is taken to the appropriate alarm activation module 360, 362 and 364 so as to activate either an audible beep alarm (if the flag value is 1) or audible ringtone alarm (if the flag value is 2) or a tactile vibrator alarm (if the alarm value is 3). If a visible flashing light type of alarm is implemented, then a corresponding flag value (e.g., 4) for that would also be checked and, if appropriate, the alarm light would be activated. Once the alarm has been activated, then control is passed to a timing loop 336, 368 waiting for an acknowledgement key to be pressed at 366 or for a time-out condition at 368 before the alarm is deactivated at 370 and exit is taken at 372.

As explained above, an exemplary timed interrupt routine for monitoring the wireless connection and generating an alarm if appropriate is schematically depicted in abbreviated form at FIGS. 3A-3B. This exemplary timed interrupt may include any desired number of different types of checks on the monitored connection. The exemplary monitored secure wireless heartbeat may typically be at the application layer of the wireless communication device (e.g., implemented as a timer). The operating system may be programmed to notify the application every N minutes to send a ping to the associated smart card reader. If the application does not receive a recognizable reply to such ping within a specified period of time, the connection may be assumed lost (or endangered) and may be closed. Similarly, the smart card reader may be programmed to close the connection from its end if it does not receive recognizable communication from the wireless communication device after N minutes. A monitored low level wireless heart beat may similarly involve a periodic non-secure low level ping communication. A monitored wireless signal power vis-a-vis a specified level may similarly involve detection (on either end) of an out of range (or endangered) situation (e.g., where successful communication takes excessive time because the RF signal is relatively weak and thus introduces numerous detected communication errors necessitating excessive retries to communicate a given packet of digital data). When the number of retries required becomes excessive (i.e., beyond a specified limit), the connection may be considered endangered or broken (and then possibly dropped).

Since those in the art should already be acquainted with the existence of a secure wireless heartbeat or other low level wireless heartbeats and/or with a monitoring of wireless signal power passing below some threshold, it is not believed necessary to further describe the details of such monitoring. Instead, the final testing for the absence of some expected characteristic feature of the monitored wireless link is simply depicted in abbreviated schematic form at 316, 318 and 320 respectively.

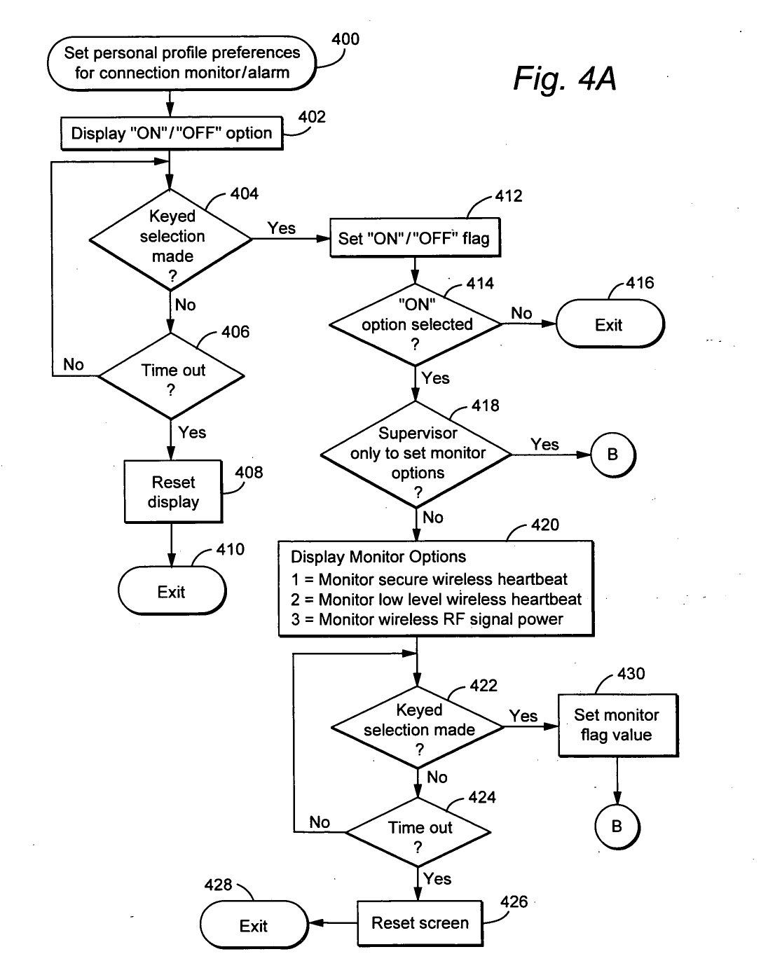

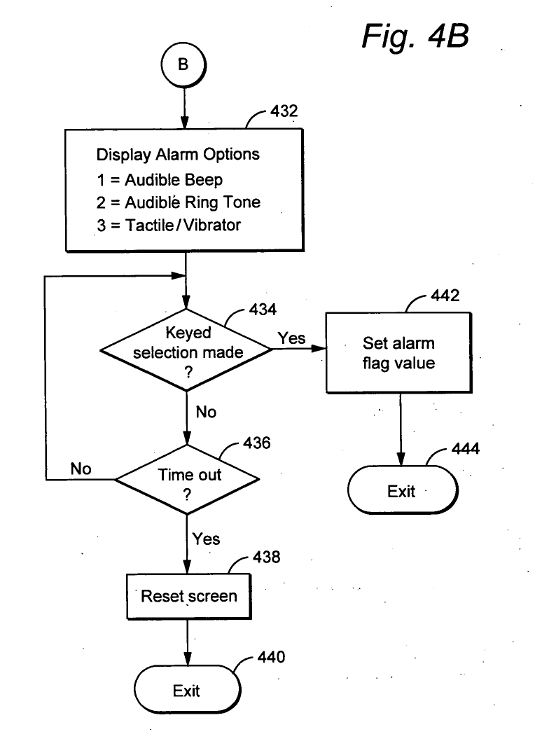

One possible program logic for setting personal profile preferences for such monitoring and/or alarming features (i.e., the flag values discussed in connection with FIGS. 3A and 3B) is depicted at FIGS. 4A and 4B. Here, if the routine is entered at 400, then an “ON”/“OFF” option is displayed at 402 and a key selection/time-out loop is entered at 404, 406 for the user to make a selection. If no selection is made within the allotted time, then the display is reset at 408 and exit is taken at 410. However, if the user makes a keyed selection, then the “ON”/“OFF” flag is set appropriately at 412. If the “ON” option has not been selected, as tested at 414, then exit is taken at 416. If the “ON” option has been selected, then a test is made at 418 to see if the system has been configured (e.g., via a downloaded IT Policy set at the enterprise administrative level) such that only a supervisor is permitted to set the options for monitoring the wireless link. If so, then control is transferred to the display and setting of alarm options by the user as depicted in FIG. 4B. However, if the user is permitted to set monitoring options, then those monitoring options are displayed at 420 (flag value 1 for monitoring secure wireless heartbeat, flag value 2 for monitoring non-secure wireless heartbeat and flag value 3 for monitoring wireless RF signal power). A key selection/time-out loop is then entered at 422, 424. If no selection is made by the user within the available time, then the screen is reset at 426 and exit is taken at 428. However, if the user has timely made a selection among the displayed options, then the monitor flag value is appropriately set at 430 before control is passed to the alarm option module of FIG. 4B.

In FIG. 4B, the alarm options for the user to select are displayed at 432 (flag value 1 equals audible beep, flag value 2 equals an audible ringtone, and flag value 3 equals a tactile/vibrator alarm). A user key selection/time-out loop is then entered at 434, 436. If the user fails to make an appropriate selection within the allotted time, then the screen is reset at 438 and exit is taken at 440. However, if the user makes an appropriate selection within the allotted time, then the alarm flag is appropriately set at 442 before the routine is exited at 444. As will be appreciated, another option (e.g., flag value 4) for selecting a visual flashing light type of alarm may also be provided.

While the above has been described in connection with presently preferred exemplary embodiments, those skilled in the art will recognize that various changes and modifications may be made to the exemplary embodiments while yet retaining many of their novel features and advantages. Accordingly, all such variations and modifications are intended to be included within the scope of the appended claims.

What is claimed is:

1. A portable wireless user communication device capable of being wirelessly coupled to a second device via a wireless link which provides a detectable characteristic while the link is operatively established, said portable wireless user communication device comprising:
a wireless link monitor which detects said characteristic; and
a user alarm which signals a user of said communication device in response to an output of the wireless link monitor representing impairment of the wireless link.

2. A portable wireless user communication device as in claim 1 wherein the user alarm is of a type selected by the user.

3. A portable wireless user communication device as in claim 2 wherein the user alarm type is user selectable from among a group of types including: (a) audible beep, (b) audible ringtone, (c) vibrator and (d) visual flashing light.

4. A portable wireless user communication device as in claim 1 wherein the detectable characteristic is selectable from a group including:
(a) a secure heartbeat signal;
(b) a non-secure heartbeat signal; and
(c) wireless link signal power dropping below a threshold level.

5. A portable wireless user communication device as in claim 1 in combination with said second device wherein said second device is also portable and comprises:
a wireless link monitor which detects a detectable characteristic of said operatively established wireless link; and
a user alarm which signals a user of the second device in response to an output of the wireless link monitor in said second device representing impairment of the wireless link.

6. A method for operating a portable wireless user communication device capable of being wirelessly coupled to a second device via a wireless link which provides a detectable characteristic while the link is operatively established, said method comprising:
monitoring a wireless link by detecting said characteristic; and
issuing a user alarm signaling a user of said communication device in response to an output of the wireless link monitor representing impairment of the wireless link.

7. A method as in claim 6 wherein the user alarm is of a type selected by the user.

8. A method as in claim 7 wherein the user alarm type is user selectable from among a group of types including: (a) audible beep, (b) audible ringtone, (c) vibrator and (d) visual flashing light.

9. A method as in claim 6 wherein the detectable characteristic is selectable from a group including:
(a) a secure heartbeat signal;
(b) a non-secure heartbeat signal; and
(c) wireless link signal power dropping below a threshold level.

10. A method as in claim 6 further comprising, in said second device:
also monitoring said wireless link by detecting a detectable characteristic of said operatively established wireless link; and
issuing a user alarm from the second device which signals a user of the second device in response to an output of the wireless link monitor in said second device representing impairment of the wireless link.

11. A digital computer program storage medium storing a computer program for controlling, when executed, the method of operation of a portable wireless user communication device capable of being wirelessly coupled to a second device via a wireless link which provides a detectable characteristic while the link is operatively established, said method comprising:
monitoring a wireless link by detecting said characteristic; and
issuing a user alarm signaling a user of said communication device in response to an output of the wireless link monitor representing impairment of the wireless link.

12. A computer program storage medium as in claim 11 wherein the user alarm is of a type selected by the user.

13. A computer program storage medium as in claim 12 wherein the user alarm type is user selectable from among a group of types including: (a) audible beep, (b) audible ringtone, (c) vibrator and (d) visual flashing light.

14. A computer program storage medium as in claim 11 wherein the detectable characteristic is selectable from a group including:
(a) a secure heartbeat signal;
(b) a non-secure heartbeat signal; and
(c) wireless link signal power dropping below a threshold level.

15. A computer program storage medium as in claim 1 for further controlling, when executed, a method of operating said second device, said method of controlling said second device comprising:
also monitoring a wireless link monitor which by detecting a detectable characteristic of said operatively established wireless link; and
issuing a user alarm from the second device which signals a user of the second device in response to an output of the wireless link monitor in said second device representing impairment of the wireless link.

16. A pair of portable devices which are capable of being wirelessly interconnected to each other via an RF link which includes a detectable characteristic, at least one of said devices comprising:
a monitor which detects the absence or impairment of said detectable characteristic; and
a user alarm which signals a user of the device of such detected absence or impairment of said detectable characteristic.

17. A pair of devices as in claim 16 wherein both of said devices include a monitor and user alarm to signal the user of said devices that the wireless connection therebetween is lost or in danger of being lost.

18. A pair of devices as in claim 16 wherein the user alarm is of a type selected by the user.

19. A pair of devices as in claim 18 wherein the user may select an alarm type from a group of types including: (a) audible beep, (b) audible ringtone, (c) vibrator and (d) visual flashing light.

20. A pair of devices as in claim 16 wherein the detectable characteristic of the RF link is of a selected type.

21. A pair of devices as in claim 20 wherein the detectable characteristic may be selected from a group of characteristics including:
(a) a secure heartbeat signal;
(b) a low level heartbeat signal; and
(c) RF signal power dropping below a specified level.
